(19) United States
(12) Patent Application Publication
(10) Pub. No.: US 2017/0295456 A1
(43) Pub. Date: Oct. 12, 2017

(54) ELECTRONIC APPARATUS, CONTROL METHOD, AND NON-TRANSITORY STORAGE MEDIUM

(71) Applicant: KYOCERA Corporation, Kyoto-shi, Kyoto (JP)

(72) Inventors: Shigeki TANABE, Yokohama-shi, Kanagawa (JP); Hideki MORITA, Yokohama-shi, Kanagawa (JP); Isao MASUIKE, Machida-shi, Tokyo (JP); Shinya SAITO, Kawasaki-shi, Kanagawa (JP)

(21) Appl. No.: 15/522,929

(22) PCT Filed: Oct. 28, 2015
(86) PCT No.: PCT/JP2015/080392

§ 371 Date: Apr. 28, 2017

(30) Foreign Application Priority Data
Oct. 30, 2014 (JP) 2014-221625

(51) Int. Cl. H04W 4/00; H02J 50/20; H04M 1/725; H04B 5/00; G06F 1/16; H02J 5/00; H02J 50/80

(52) U.S. Cl. CPC H04W 4/008; H02J 5/005; H02J 50/20; H02J 50/80; H04B 5/0025; G06F 1/1626; H04M 1/7253

(57) ABSTRACT

An electronic apparatus includes a short range wireless communicator, a motion sensor, and at least one controller configured to make active transmission available in the short range wireless communicator when a state of the electronic apparatus is determined to have transitioned from a first state to a second state in a case where the active transmission is unavailable in the short range wireless communicator.

### FIELD

The present application relates to an electronic apparatus, a control method, and a control program.

### BACKGROUND

In electronic apparatuses such as a mobile phone and a smartphone, a communication is performed by using a short range wireless communication method. For example, Patent Literature 1 discloses a technology of performing a short range wireless communication with an external apparatus by using a short-range wireless circuit and an interface.

### CITATION LIST

### Patent Literature

Patent Literature 1: Japanese Laid-open Patent Publication No. 2002-329223 A

### SUMMARY

In the above-described electronic apparatuses, there is room for an improvement in the short range wireless communication method.

According to one aspect, there is provided a electronic apparatus, comprising: a short range wireless communicator; a motion sensor; and at least one controller configured to make active transmission available in the short range wireless communicator when a state of the electronic apparatus is determined to have transitioned from a first state to a second state in a case where the active transmission is unavailable in the short range wireless communicator.

According to one aspect, there is provided a control method that is executed by an electronic apparatus including a short range wireless communicator and a motion sensor, the control method comprising: determining a state of the electronic apparatus based on the motion sensor when the short range wireless communicator is in a state in which active transmission is unavailable; and making the active transmission available in the short range wireless communicator when the state of the electronic apparatus is determined to have transitioned from the first state to the second state.

According to one aspect, there is provided a control program allowing an electronic apparatus including a short range wireless communicator and a motion sensor to execute: determining a state of the electronic apparatus based on the motion sensor when the short range wireless communicator is in a state in which active transmission is unavailable; and making the active transmission available in the short range wireless communicator when the state of the electronic apparatus is determined to have transitioned from the first state to the second state.

### BRIEF DESCRIPTION OF DRAWINGS

FIG. 1 is a perspective view of a smartphone according to embodiments.

FIG. 2 is a front view of the smartphone.

FIG. 3 is a rear view of the smartphone.

FIG. 4 is a block diagram of the smartphone.

FIG. 5 is a view illustrating an example of a control according to a short range wireless communication with the smartphone.

FIG. 6 is a flowchart illustrating a procedure of the example of the control with the smartphone.

FIG. 7 is a flowchart illustrating a procedure corresponding to another example of the control with the smartphone.

FIG. 8 is a flowchart illustrating a procedure corresponding to still another example of the control with the smartphone.

### DETAILED DESCRIPTION

A plurality of embodiments for executing an electronic apparatus, a control method, and a control program according to this application will be described in detail with reference to the accompanying drawings. Hereinafter, description will be given of a smartphone as an example of the electronic apparatus.

### Embodiments

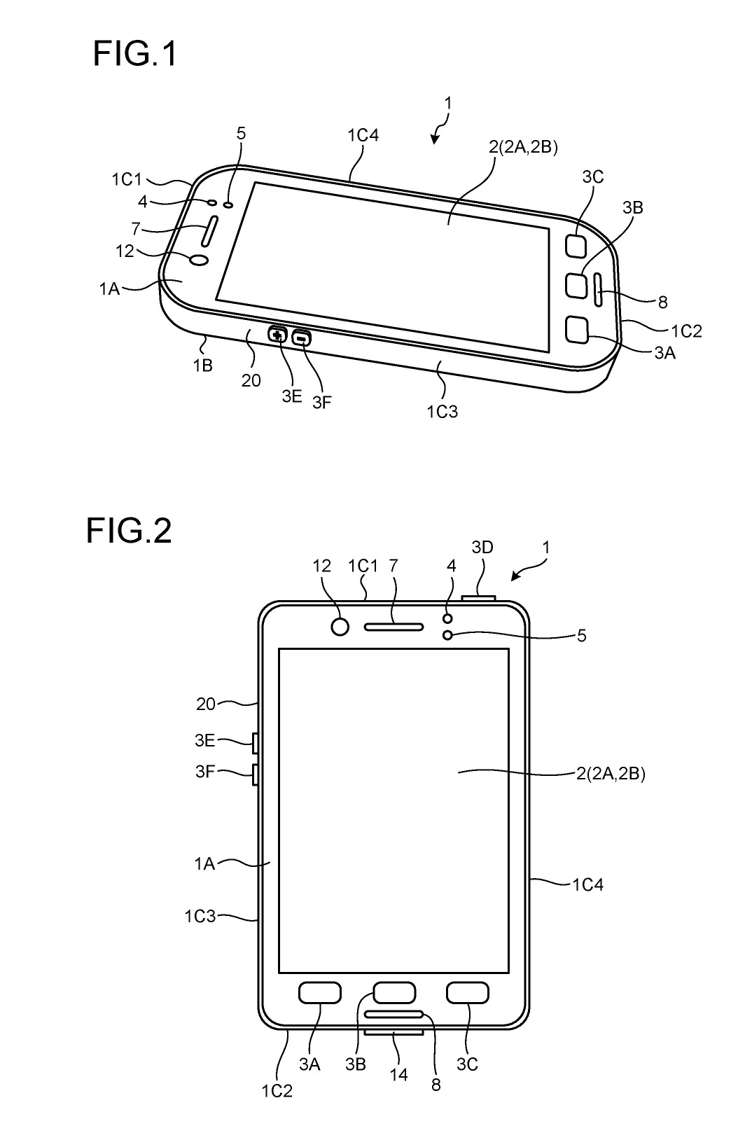

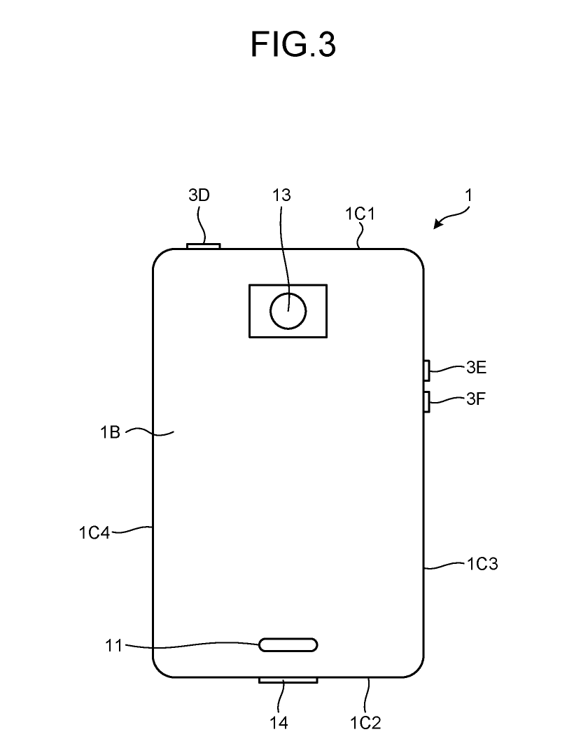

Description will be given of an overall configuration of a smartphone 1 that is an example of an electronic apparatus with reference to FIG. 1 to FIG. 3. As illustrated in FIG. 1 to FIG. 3, the smartphone 1 includes a housing 20. The housing 20 includes a front face 1A, a rear face 1B, and side faces 1C1 to 1C4. The front face 1A is a front surface of the housing 20. The rear face 1B is a rear surface of the housing 20. The side faces 1C1 to 1C4 are lateral surfaces which connect the front face 1A and the rear face 1B. Hereinafter, the side faces 1C1 to 1C4 may be collectively referred to as a side face 1C without specifying a certain surface.

The smartphone 1 includes a touch screen display 2, buttons 3A to 3C, an illuminance sensor 4, a proximity sensor 5, a receiver 7, a microphone 8, and a camera 12 on the front face 1A. The smartphone 1 includes a speaker 11 and a camera 13 on the rear face 1B. The smartphone 1 includes buttons 3D to 3F, and a connector 14 on the side face 1C. Hereinafter, the buttons 3A to 3F may be collectively referred to as a button 3 without specifying a certain button.

The touch screen display 2 includes a display 2A and a touch screen 2B. In the example of FIG. 1, the display 2A and the touch screen 2B have an approximately rectangular shape, but the shape of the display 2A and the touch screen 2B is not limited thereto. Each of the display 2A and the touch screen 2B may have an arbitrary shape such as a square shape and a circular shape. In the example of FIG. 1, the display 2A and the touch screen 2B are positioned to overlap each other, but the position of the display 2A and the touch screen 2B is not limited thereto. For example, the display 2A and the touch screen 2B may be positioned in parallel, or may be positioned to be spaced away. In the example of FIG. 1, a long side of the display 2A conforms to a long side of the touch screen 2B, and a short side of the display 2A conforms to a short side of the touch screen 2B, but a state of overlapping the display 2A and the touch screen 2B is not limited thereto. In a case where the display 2A and the touch screen 2B are positioned to overlap each other, for example, one or a plurality of sides of the display 2A may not conform to any side of the touch screen 2B.

The display 2A includes a display device such as a liquid crystal display (LCD), an organic electro-luminescence display (OELD), and an inorganic electro-luminescence display (IELD). The display 2A displays a character, an image, a symbol, and a figure.

The touch screen 2B detects contact of a finger, a pen, a stylus pen, and the like with respect to the touch screen 2B. The touch screen 2B may detect a position at which a plurality of the fingers, the pen, the stylus pen, and the like comes into contact with the touch screen 2B. In the following description, the fingers, the pen, the stylus pen, and the like, which come into contact with the touch screen 2B, may be referred to as “contact object”.

A detection type of the touch screen 2B may be an arbitrary type such as an electrostatic capacitance type, a resistive film type, a surface acoustic wave type (or an ultrasonic wave type), an infrared ray type, an electromagnetic induction type, and a load detection type. In the following description, it is assumed that a user comes into contact with the touch screen 2B with a finger so as to operate the smartphone 1 for simple explanation.

The smartphone 1 determines a type of a gesture, based on at least one of: a contact detected by the touch screen 2B; a position at which the contact has been detected; a change in position at which the contact has been detected; an interval between detection of contacts; and the number of times that a contact has been detected. The gesture is an operation performed on the touch screen 2B. Examples of a gesture which are determined by the smartphone 1 include, but are not limited to, touch, long touch, release, swipe, tap, double tap, long tap, drag, flick, pinch in, and pinch out.

The smartphone 1 performs an operation in accordance with the gesture determined through the touch screen 2B. Accordingly, intuitive and convenient operability is realized for a user. An operation, which is performed by the smartphone 1 in accordance with the determined gesture, may be different depending on a screen that is displayed on the display 2A. In the following description, “the touch screen 2B detects contact, and the smartphone 1 determines a type of a gesture as X based on the detected contact” may be described as “the smartphone detects X” or “a controller detects X” for simple explanation.

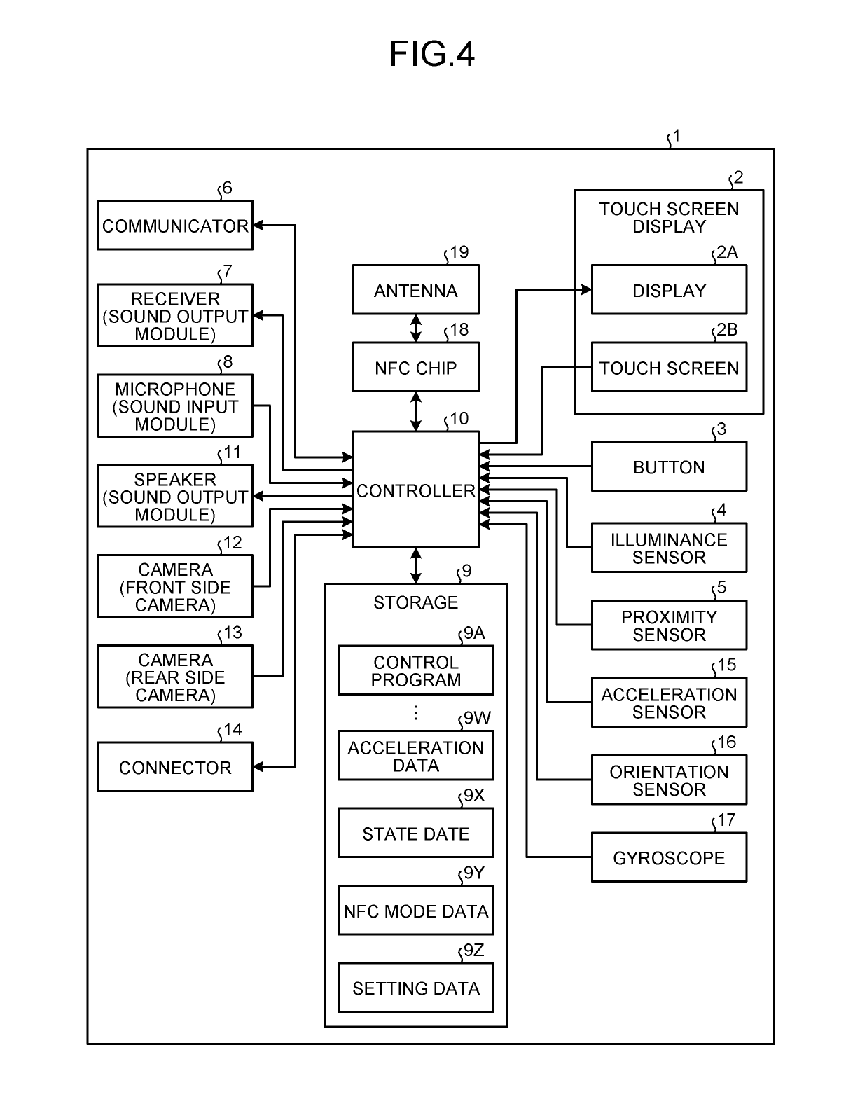

FIG. 4 is a block diagram of the smartphone 1. The smartphone 1 includes the touch screen display 2, the button 3, the illuminance sensor 4, the proximity sensor 5, a communicator 6, the receiver 7, the microphone 8, a storage 9, a controller 10, the speaker 11, the cameras 12 and 13, the connector 14, an acceleration sensor 15, an orientation sensor 16, a gyroscope 17, an NFC chip 18, and an antenna 19.

As described above, the touch screen display 2 includes the display 2A and the touch screen 2B. The display 2A displays a character, an image, a symbol, a figure, and the like. The touch screen 2B detects contact. The controller 10 detects a gesture with respect to the smartphone 1. Specifically, the controller 10 detects an operation (gesture) with respect to the touch screen 2B (the touch screen display 2) in cooperation with the touch screen 2B.

The button 3 is operated by a user. The button 3 includes the button 3A to button 3F. The controller 10 detects an operation with respect to the button 3 in cooperation with the button 3. Examples of the operation with respect to the button 3 include, but are not limited to, click, double click, triple click, push, and multi-push.

Examples of the buttons 3A to 3C include, but are not limited to, a home button, a back button, and a menu button. Examples of the button 3D include, but are not limited to, a power on/off button of the smartphone 1. The button 3D may also serve as a sleep/sleep release button. Examples of the buttons 3E and 3F include, but are not limited to, a volume button.

The illuminance sensor 4 detects illuminance of ambient light of the smartphone 1. The illuminance is a value of a luminous flux that is incident on a unit area of a measurement surface in the illuminance sensor 4. For example, the illuminance sensor 4 is used to adjust luminance of the display 2A. The proximity sensor 5 detects existence of a neighborhood object in a non-contact manner. The proximity sensor 5 detects existence of an object based on a change of a magnetic field, a change of a returning time of a reflected wave of an ultrasonic wave, and the like. For example, the proximity sensor 5 detects approaching of the touch screen display 2 to a face. The illuminance sensor 4 and the proximity sensor 5 may be constituted as one sensor. The illuminance sensor 4 may be used as a proximity sensor.

The communicator 6 performs a wireless communication. A communication mode, which is supported by the communicator 6, is a wireless communication standard. Examples of the wireless communication standard include, but are not limited to, communication standard of a cellular phone such as 2G, 3G, and 4G. Examples of the communication standards of the cellular phone include, but are not limited to, long term evolution (LTE), wideband code division multiple access (W-CDMA), CDMA 2000, personal digital cellular (PDC), global system for mobile communications (GSM; registered trademark), personal handy-phone system (PHS), and the like. In addition, examples of the radio communication standards include, but are not limited to, worldwide interoperatbility for microwave access (WiMAX), IEEE 802.11, Bluetooth (registered trademark), infrared data association (IrDA), and the like. The communicator 6 may support one or a plurality of the above-described communication standards.

The receiver 7 and the speaker 11 are sound output modules. The receiver 7 and the speaker 11 output a sound signal, which is transmitted from the controller 10, as sound. For example, the receiver 7 is used to output a sound of a counterpart on calling. For example, the speaker 11 is used to output a ring tone and music. One of the receiver 7 and the speaker 11 may also serve as a function of the other. The microphone 8 is a sound input module. The microphone 8 converts a voice of a user and the like into a sound signal, and transmits the sound signal to the controller 10.

The storage 9 stores a program and data. The storage 9 is also used as a work area that temporarily stores a processing result of the controller 10. The storage 9 may include an arbitrary non-transitory storage medium such as a semiconductor storage medium and a magnetic storage medium. The storage 9 includes a plurality of kinds of storage media. The storage 9 may include a combination of a portable storage medium such as a memory card, an optical disc, and a magneto-optical disc, and a reading device of the storage medium. The storage 9 may include a storage device that is used as a temporary storage region such as a random access memory (RAM).

A program that is stored in the storage 9 includes an application that is executed at a foreground or a background, and a control program that supports an operation of the application. For example, the application allows the display 2A to display a screen, and allows the controller 10 to execute processing corresponding to a gesture detected through the touch screen 2B. Examples of the control program include, but are not limited to, OS. The application and the control program may be installed in the storage 9 through a wireless communication by the communicator 6 or a non-transitory storage medium.

For example, the storage 9 stores a control program 9A, acceleration data 9W, state data 9X, NFC mode data 9Y, and setting data 9Z. The acceleration data 9W include information relating to acceleration that acts on the smartphone 1. The state data 9X includes information relating to a state of the smartphone 1. The NFC mode data 9Y includes information relating to an operation mode of a near field communication (NFC) chip 18. The setting data 9Z includes information relating to various kinds of setting relating to an operation of the smartphone 1.

The control program 9A may provide a function relating to various controls for activation of the smartphone 1. For example, the control program 9A controls the communicator 6, the receiver 7, the microphone 8, and the like to realize a call. A function that is provided by the control program 9A includes a function of performing various controls such as changing of information displayed on the display 2A depending on a gesture detected through the touch screen 2B. The function provided by the control program 9A may be used in combination with a function provided by another program.

A plurality of pieces of acceleration information, which are transmitted as a detection result of the acceleration sensor 15, are stored in the acceleration data 9W in time series. The acceleration information includes items such as time and an acceleration value. The time represents time at which acceleration is detected by the acceleration sensor 15. The acceleration value represents an acceleration value that is detected by the acceleration sensor 15.

The control program 9A may provide a function of determining a state of the smartphone 1 based on a detection result of the acceleration sensor 15. The state of the smartphone 1 includes a first state and a second state. The first state includes a state in which a user who carries an own apparatus is in action. For example, the first state includes a walking state, a traveling state, a held state, and the like. The walking state is a state in which the user who carries the own apparatus is in walking. The traveling state is a state in which the user who carries the own apparatus is traveling. The held state is a state in which the user who holds the own apparatus with a hand moves or rests. The second state is a state in which the own apparatus is held over a reader/writer, an IC tag, and the like of another apparatus. When the smartphone 1 is held over the reader/writer, the IC tag, and the like of the other apparatus, the smartphone 1 can perform a communication with an IC chip that is included in the reader/writer, the IC tag, and the like of the other apparatus. The second state includes a rest state. For example, the rest state includes a state in which the own apparatus is momently stopped, a state in which the own apparatus is put on, a state in which the own apparatus is moving while keeping its attitude constantly (for example, a state in which the own apparatus is moving, so-called, is sliding while keeping a predetermined surface of the housing 20 in parallel with respect to a surface for communication of the reader/writer, the IC tag, and the like of the other apparatus), and the like.

The smartphone 1 can acquire a pattern such as a frequency and amplitude of vibration, and the like in a state in which a user carries the smartphone 1 with a hand by using the acceleration sensor 15. The controller 10 executes the control program 9A to perform a control of analyzing the frequency and the amplitude of the vibration and the like which are detected by the acceleration sensor 15 to determine a state of the smartphone 1. For example, when determining the state of the smartphone 1, the controller 10 may use data of acceleration patterns corresponding to various states. For example, the acceleration patterns are stored in the storage 9 in advance as determination data. The controller 10 may compare the acceleration data 9W indicating a detection result acquired from the acceleration sensor 15 and the data of acceleration patterns to determine a state that is correlated to the matched data of acceleration pattern as the state of the smartphone 1. Matching between the acceleration data 9W and the data of acceleration pattern includes a case of matching completely and a case of matching in a predetermined ratio. The controller 10 stores the determined state of the smartphone 1 in the state data 9X.

For example, in a case where a user holding the smartphone 1 in a hand holds the smartphone 1 over the reader/writer of the other apparatus, the smartphone 1 is in a state of being proximity to the reader/writer of the other apparatus, or a state of being put on the reader/writer of the other apparatus. That is, in a case of being held over the reader/writer of the other apparatus, the smartphone 1 is moved to the vicinity of a reading module of the reader/writer of the other apparatus, and a state of resting stationary remains.

In this embodiment, description has been given of a case where the state in which the smartphone 1 is held over the reader/writer, the IC tag, and the like of the other apparatus is included in the rest state, but there is no limitation thereto. For example, the smartphone 1 may further have acceleration pattern data for determination which corresponds to a series of operations for holding the own device over the reader/writer of the other apparatus. The held-over state may be separated from the rest as a different determination state by using the acceleration pattern data for determination which corresponds to the series of operations for holding the own device over the reader/writer of the other apparatus.

The state data 9X may store state information indicating a transition state. When determining transition from a current state to another state, the controller 10 can update the state information of the state data 9X so as to indicate a transitioned state. The NFC mode data 9Y can store mode information indicating a mode of NFC chip 18 in operation. A mode of the NFC chip 18 will be described later. When the mode of the NFC chip 18 is changed, the controller 10 can update the mode information so as to indicate the changed mode. The setting data 9Z includes NFC information indicating whether an NFC function of the smartphone 1 is valid or invalid.

In this embodiment, description has been given of a case where the smartphone 1 uses the acceleration sensor 15 as a motion sensor, but there is no limitation thereto. For example, the smartphone 1 may use the gyroscope 17, the orientation sensor 16, the proximity sensor 5, an atmospheric sensor, an infrared motion sensor, and the like as the motion sensor, and may use various sensors in combination.

The controller 10 is an arithmetic processing device. Examples of the arithmetic processing device include, but are not limited to, a central processing unit (CPU), a system-on-a-chip (SoC), a micro control unit (MCU), a field-programmable gate array (FPGA), and a co-processor. The controller 10 can integrally control an operation of the smartphone 1 in cooperation with various devices. Various functions of the controller 10 are realized based on a control of the controller 10.

Specifically, the controller 10 can execute a command that is included in a program stored in the storage 9. The controller 10 can refer to data that is stored in the storage 9 as necessary. The controller 10 controls functional modules based on data and a command. The controller 10 controls the functional modules to realize various functions. Examples of the functional modules include, but are not limited to, the display 2A, the communicator 6, the receiver 7, and the speaker 11. The controller 10 may change a control based on a detection result of a detection module. Examples of the detection module include, but are not limited to, the touch screen 2B, the button 3, the illuminance sensor 4, the proximity sensor 5, the microphone 8, the camera 12, the camera 13, the acceleration sensor 15, the orientation sensor 16, the gyroscope 17, and the NFC chip 18.

For example, the controller 10 executes the control program 9A to execute various controls such as changing of information displayed on the display 2A based on a gesture detected through the touch screen 2B.

The camera 12 is a front side camera that captures an image of an object that faces the front face 1A. The camera 13 is a rear side camera that captures an image of an object that faces the rear face 1B.

The connector 14 is a terminal to which another apparatus is connected. The connector 14 may be a general-purpose terminal such as a universal serial bus (USB), a high-definition multimedia interface (HDMI (registered trademark)), a light peak (Thunderbolt (registered trademark)), and an earphone microphone connector. The connector 14 may be a dedicated terminal such as a Dock connector. Examples of the apparatus that is connected to the connector 14 include, but are not limited to, an external storage, a speaker, and a communication device.

The acceleration sensor 15 can detect a direction and magnitude of acceleration that acts on the smartphone 1, an inclination angle of the smartphone 1, and a direction and magnitude of acceleration of gravity. The orientation sensor 16 can detect a direction of the terrestrial magnetism. The gyroscope 17 can detect an angle and an angular velocity of the smartphone 1. Detection results of the acceleration sensor 15, the orientation sensor 16, and the gyroscope 17 may be used in combination so as to detect a variation of a position, an attitude, and a state of the smartphone 1.

The NFC chip 18 is an IC chip that performs a short range wireless communication using NFC standards. The NFC chip 18 can perform the short range wireless communication through the antenna 19. The antenna 19 is disposed to be close to the rear face 1B inside the housing 20. Thus, in the NFC chip 18, in a case where a portion of the rear face 1B of the housing 20, in which the antenna 19 is disposed, is held over the reader/writer, the IC tag, and the like of the other apparatus, stronger field intensity of the short range wireless communication can be available.

A storage region is provided in the NFC chip 18. For example, information relating to various electronic moneys, information relating to a communication history, and the like are stored in the storage region. Examples of the information relating to the electronic moneys include, but are not limited to, card information, balance information, information necessary for identification, information relating to a billing method, and the like.

The NFC chip 18 can transmit information that is stored in the storage region to the reader/writer of the other apparatus, or can receive information that is transmitted from the reader/writer of the other apparatus through a communication with the reader/writer of the other apparatus. The NFC chip 18 can store the received information in the storage region. In this manner, the NFC chip 18 can perform billing processing and individual identification processing through the communication with the reader/writer of the other apparatus, and can perform updating of the stored information or rewriting of the balance information that corresponds to using or charging. In addition, the NFC chip 18 can perform reading and rewriting of information of the IC tag through the communication with the IC tag.

The NFC chip 18 includes a plurality of operation modes. In this embodiment, description will be given of an example in which the operation modes of the NFC chip 18 include a standby mode and a reader/writer mode. For example, the NFC chip 18 may include another mode such as a mode (so-called a card emulation mode) which passively operates by acquiring power through electromagnetic induction by using an electric wave that is transmitted from the reader/writer of the other apparatus, and a mode (so-called P2P mode) of performing pairing by a bidirectional data communication between two devices each of which includes an NFC chip.

The standby mode is a mode in which power supply of the NFC chip 18 is turned on, but an operation thereof is suppressed to the minimum, or a mode in which the power supply of the NFC chip 18 is turned off. The standby mode is a mode in which power is further saved in comparison to another mode. For example, the NFC chip 18 in the standby mode detects a carrier wave from the reader/writer of the other apparatus, but a function of transmitting the carrier wave to the outside is turned off. That is, when operating in the standby mode, the NFC chip 18 is in a state in which active transmission is unavailable. The state in which active transmission is unavailable is a state in which the NFC chip 18 does not transmit the carrier wave.

The reader/writer mode is a mode in which the NFC chip 18 continuously or periodically transmits the carrier wave to the outside of the smartphone 1, and performs a communication with the reader/writer, the IC tag, and the like of the other apparatus. For example, in the NFC chip 18 in the reader/writer mode, a function of transmitting the carrier wave to the outside is turned on. That is, when operating in the reader/writer mode, the NFC chip 18 is in a state in which active transmission is available. The state in which active transmission is available is a state in which the NFC chip 18 transmits the carrier wave. In a case of the reader/writer mode, the NFC chip 18 continuously or periodically transmits the carrier wave, and thus power is further consumed in comparison to the standby mode.

When the controller 10 makes a request for the NFC chip 18 to transition to the standby mode, the NFC chip 18 transitions to the standby mode. For example, the controller 10 makes a request for the NFC chip 18 to transition to the standby mode in a case where a possibility of using an NFC communication on a user side is low such as a case of turning off the touch screen display 2, and a case of detecting a start of walking or traveling.

In FIG. 4, a part or a whole of the program and the data which are stored in the storage 9 may be downloaded from another device through a wireless communication by the communicator 6. In FIG. 4, a part or a while of the program and the data which are stored in the storage 9 may be stored in a non-transitory storage medium that is readable by the reading device included in the storage 9. In FIG. 4, a part or a whole of the program and the data which are stored in the storage 9 may be stored in a non-transitory storage medium that is readable by the reading device connected to the connector 14. Examples of the non-transitory storage medium include, but are not limited to, an optical disc such as CD (registered trademark), DVD (registered trademark), and Blu-ray (registered trademark), a magneto-optical disc, a magnetic storage medium, a memory card, and a solid state storage medium.

The configuration of the smartphone 1 in FIG. 4 is illustrative only, and may be appropriately changed in a range not departing from the gist of this application. For example, the number and the kind of the button 3 are not limited to the example of FIG. 4. The smartphone 1 may include buttons with a numeric keypad layout and a QWERTY layout as buttons for an operation with respect to a screen instead of the buttons 3A to 3C. The smartphone 1 may include only one button for an operation with respect to a screen, or may not include the button. In the example illustrated in FIG. 4, the smartphone 1 includes two cameras. However, the smartphone 1 may include only one camera, or may not include the camera. In the example illustrated in FIG. 4, the smartphone 1 includes four kinds of sensors so as to detect a position and an attitude thereof. However, the smartphone 1 may not include some of the sensors. Alternatively, the smartphone 1 may include another kind of sensor that detects at least one of the position and the attitude thereof.

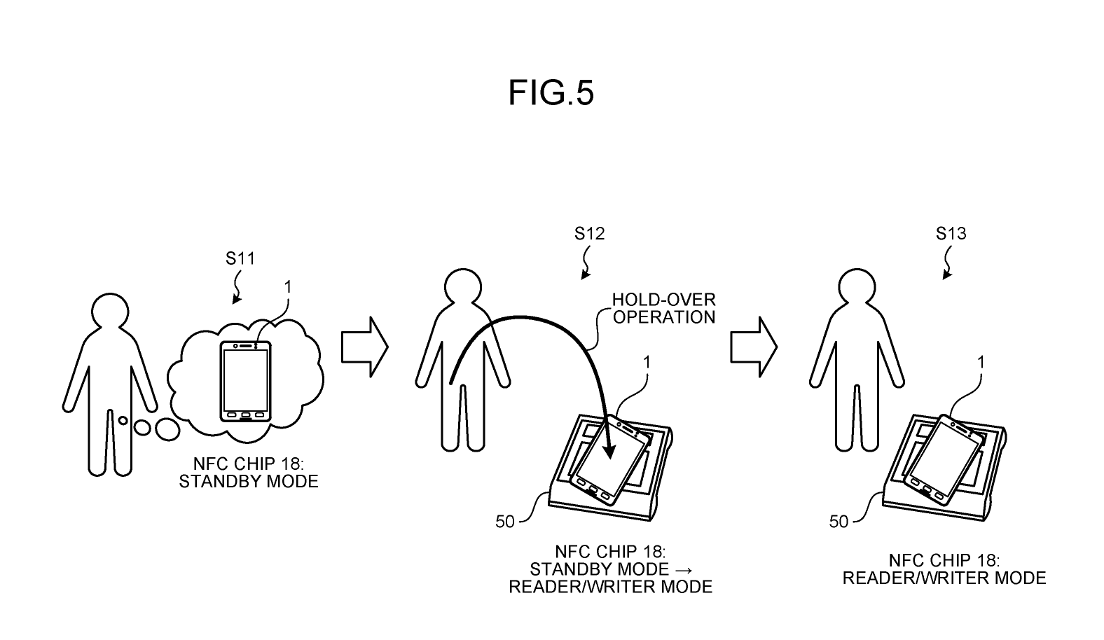

FIG. 5 is a view illustrating an example of a control according to a short range wireless communication by the smartphone 1. In the following description, the same reference numeral will be given to the same constituent element, and redundant description may be omitted in some cases.

At Step S11 illustrated in FIG. 5, the smartphone 1, of which the NFC chip 18 is in a standby mode, is held in a pocket of his/her trouser in a walking state. At Step S11, the smartphone 1 allows the acceleration sensor 15 to operate so as to monitor a state of the smartphone 1. In this case, when at least the controller 10 and the acceleration sensor 15 are allowed to operate, the smartphone 1 can realize a monitor of the state thereof.

Then, for example, the user approaches an NFC reader/writer 50 for payment processing so as to perform the payment processing at a ticket gate of a station, in a shop, and the like. The NFC reader/writer 50 acquires information necessary for the payment processing from an IC chip and the like through a short range wireless communication. The NFC reader/writer 50 performs the payment processing, authentication processing, and the like based on the acquired information. In addition, the NFC reader/writer 50 transmits information, which indicates a processing result, to the IC chip and the like.

At Step S12, the user holds the smartphone 1, which is taken out from a pocket, with a hand, and performs an operation of holding the smartphone 1 over the NFC reader/writer 50. In this case, the NFC chip 18 of the smartphone 1 is in the standby mode, and thus the NFC chip 18 is in a state in which transmission of a carrier wave is unavailable. For example, the operation of holding the smartphone 1 over the NFC reader/writer 50 by the user includes an operation of moving the own apparatus closer to the reading module of the NFC reader/writer 50 to rest thereover, an operation of moving the own apparatus closer to the reading module to put thereon, an operation of sliding the own apparatus in a state of being close to the reading module, and the like.

In this embodiment, in the smartphone 1, the antenna 19 of the NFC chip 18 is disposed to be close to the rear face 1B inside the housing 20. Thus, in a case where the smartphone 1 is held over the NFC reader/writer 50, in the smartphone 1, the rear face 1B faces the NFC reader/writer 50. In this case, in the smartphone 1, the front face 1A may be covered with a hand of the user.

At Step S12, the user holds the smartphone 1 over the NFC reader/writer 50, and rest the smartphone 1 in the held-over state. At Step S12, the smartphone 1 determines that the smartphone 1 transitions from a held state in which the own apparatus is held with a hand to a rest state based on a detection result that is detected by the acceleration sensor 15. Then, the smartphone 1 allows the NFC chip 18 to transition from the standby mode to a reader/writer mode. As a result, the NFC chip 18 is in a state in which transmission of a carrier wave is available.

In this manner, even when the NFC chip 18 is always operated in the standby mode, the smartphone 1 can allow the NFC chip 18 to automatically transition to the reader/writer mode in a case where the NFC chip 18 is required to be operated. As a result, it is not necessary for the user of the smartphone 1 to intentionally perform setting change in order to change the mode of the NFC chip 18 to the reader/writer mode.

For example, in a case where the NFC chip 18 is always in the reader/writer mode, a carrier wave is continuously transmitted from the NFC chip 18 to the outside, and thus there is a concern that power consumption of the smartphone 1 increases. However, in the standby mode in which active transmission is unavailable, the NFC chip 18 does not transmit the carrier wave, and thus it is possible to realize power saving in the smartphone 1. Even when the NFC chip 18 is always operated in a state in which active transmission is unavailable, the smartphone 1 can switch its mode without inconvenience for the user, and it is possible to suppress power consumption of the smartphone 1 due to the NFC chip 18.

At Step S13, the user keeps a state in which the smartphone 1 is held over the NFC reader/writer 50. In addition, when receiving the carrier wave from the NFC reader/writer 50, the NFC chip 18 of the smartphone 1 transmits information, which is necessary for payment, to the NFC reader/writer 50, and receives information, which indicates a payment result, from the NFC reader/writer 50. In addition, the NFC chip 18 stores the information, which indicates the payment result, in a storage region.

Furthermore, after the short range wireless communication is terminated, the smartphone 1 may keep the reader/writer mode of the NFC chip 18, or may allow the NFC chip 18 to transition from the reader/writer mode to the standby mode after a predetermined time. For example, in a case of switching the touch screen display 2 from a turned-on state to a turned-off state, the smartphone 1 may allow the NFC chip 18 to transition from the reader/writer mode to the standby mode. For example, in a case where the NFC chip 18 is in the standby mode, even when the touch screen display 2 is switched from the turned-off state to the turned-on state, the smartphone 1 may keep the standby mode of the NFC chip 18.

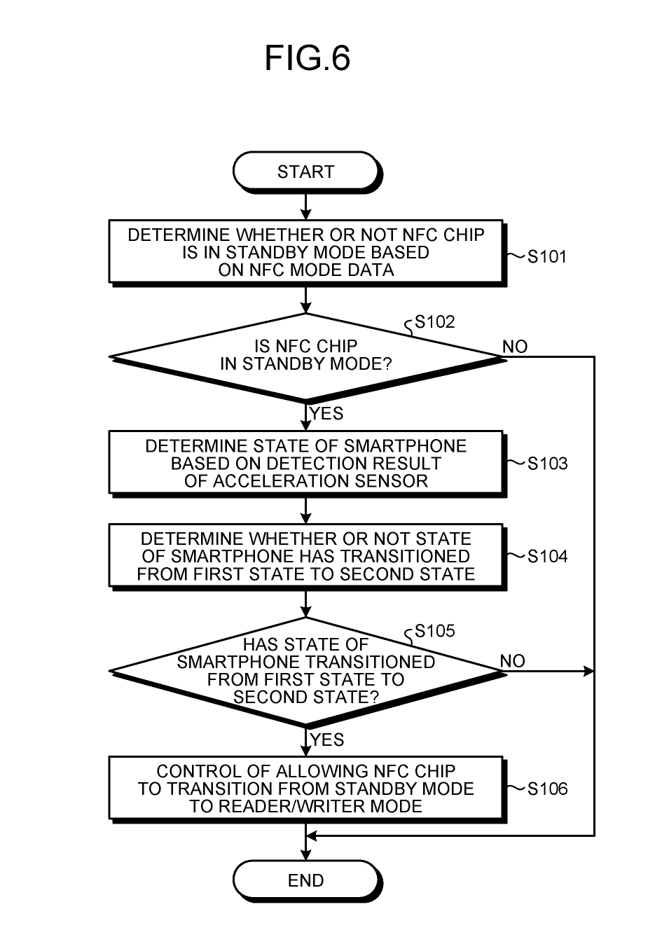

FIG. 6 is a flowchart illustrating a procedure of an example of a control by the smartphone 1. The procedure illustrated in FIG. 6 is realized when the controller 10 executes the control program 9A. The procedure illustrated in FIG. 6 is repetitively executed in a case where the smartphone 1 performs a control.

As illustrated in FIG. 6, at Step S101, the controller 10 of the smartphone 1 determines whether or not the NFC chip 18 is in the standby mode based on the NFC mode data 9Y of the storage 9. In a case where the NFC chip 18 is not in the standby mode (Step S102, No), the controller 10 terminates the procedure illustrated in FIG. 6.

In a case where the NFC chip 18 is in the standby mode (Step S102, Yes), the controller 10 proceeds to Step S103. At Step S103, the controller 10 determines a state of the smartphone 1 based on a detection result of the acceleration sensor 15, and stores the determination result in the storage 9. Specifically, the controller 10 compares a detection result of acceleration detected by the acceleration sensor 15 and acceleration pattern data with each other, and determines information, which is correlated to matched acceleration pattern data, as a state of the smartphone 1.

Subsequently, at Step S104, the controller 10 determines whether or not the state of the smartphone 1 has transitioned from a first state to a second state based on the state that is determined at Step S103 and state data of the storage 9, and stores the determination result in the storage 9. In this embodiment, the second state represents a rest state, and the controller 10 determines whether or not the state of the smartphone 1 transitions to the rest state.

In a case where the state of the smartphone 1 has not transitioned from a first state to a second state (Step S105, No), there is a low possibility that the smartphone 1 is held over the NFC reader/writer 50 and the like, and thus the controller 10 terminates the procedure illustrated in FIG. 6.

In a case where the state of the smartphone 1 has transitioned from a first state to a second state (Step S105, Yes), there is a high possibility that the smartphone 1 is held over the NFC reader/writer 50 and the like, and thus the controller 10 proceeds to Step S106. At Step S106, the controller 10 performs a control of allowing the NFC chip 18 to transition from the standby mode to the reader/writer mode. Specifically, the controller 10 makes a request for the NFC chip 18 to transition to the reader/writer mode, and updates mode information of the NFC mode data 9Y to the reader/writer mode. Then, the controller 10 terminates the procedure illustrated in FIG. 6.

Some embodiments disclosed in this application can be changed in a range not departing from the gist and the range of this application. In addition, some embodiments disclosed in this application may be appropriately combined. For example, the above-described embodiment may be modified as follows.

For example, the programs illustrated in FIG. 4 may be divided into a plurality of modules, or may be combined with another program.

For example, an operation in which the user places the smartphone 1 on a table, a writing table, and the like, and an operation in which the user holds the smartphone 1 over the NFC reader/writer 50 may be similar to each other. Accordingly, description will be given of an example of a control corresponding to the operation for the holding-over and the placing of the smartphone 1.

In a case where the NFC chip 18 operates in the standby mode, the smartphone 1 can determine the state of the own apparatus based on the detection result of the acceleration sensor 15. In a case where it is determined that the smartphone 1 transitions from a held state in which the own apparatus is held with a hand to a rest state, the hold-over operation may have been performed by the user, and thus the NFC chip 18 is allowed to transition from the standby mode to the reader/writer mode. As a result, the NFC chip 18 is in a state in which active transmission is available.

In a case where the smartphone 1 is held over the NFC reader/writer 50, the IC tag, and the like, the NFC chip 18 in the reader/writer mode performs the short range wireless communication. However, in a case where the smartphone 1 is placed on a table, a writing table, and the like, the NFC chip 18 does not perform the short range wireless communication. Accordingly, after the NFC chip 18 transitions to the reader/writer mode, the smartphone 1 determines whether or not the NFC chip 18 performs a communication until a predetermined time has passed. The predetermined time is a time for determining the hold-over operation and the placing operation.

In a case where a communication is performed by the NFC chip 18 until the predetermined time has passed, the smartphone 1 determines that the smartphone 1 is in a state of being held over the NFC reader/writer 50, the IC tag, and the like, and keeps the reader/writer mode of the NFC chip 18. In a case where a communication is not performed by the NFC chip 18 until the predetermined time has passed, the smartphone 1 allows the NFC chip 18 to transition from the reader/writer mode to the standby mode. As a result, the NFC chip 18 is in a state in which active transmission is unavailable.

In this manner, after the NFC chip 18 is automatically allowed to transition to the reader/writer mode based on the detection result of the acceleration sensor 15, in a case where a communication is not performed by the NFC chip 18, the smartphone 1 can allow the NFC chip 18 to return to the standby mode. As a result, the smartphone 1 can determine the hold-over operation and the placing operation by the user, and can easily realize power saving.

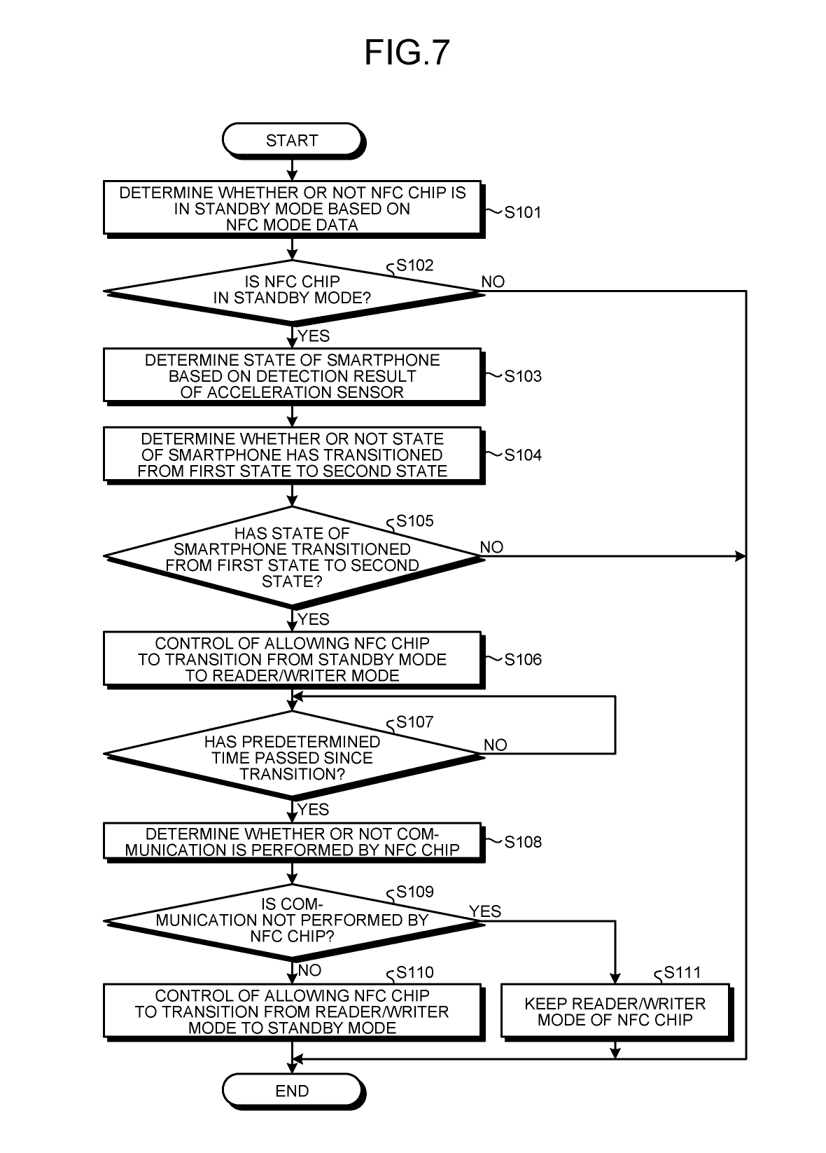

FIG. 7 is a flowchart illustrating a procedure corresponding to another example of a control by the smartphone 1. The procedure illustrated in FIG. 7 is realized when the controller 10 executes the control program 9A. The procedure illustrated in FIG. 7 is repetitively executed in a case where the smartphone 1 performs a control.

As illustrated in FIG. 7, at Step S101, the controller 10 of the smartphone 1 determines whether or not the NFC chip 18 is in the standby mode based on the NFC mode data 9Y of the storage 9. In a case where the NFC chip 18 is not in the standby mode (Step S102, No), the controller 10 terminates the procedure illustrated in FIG. 7.

In a case where the NFC chip 18 is in the standby mode (Step S102, Yes), the controller 10 proceeds to Step S103. At Step S103, the controller 10 determines a state of the smartphone 1 based on the detection result of the acceleration sensor 15, and stores the determination result in the storage 9.

Subsequently, at Step S104, the controller 10 determines whether or not the state of the smartphone 1 has transitioned from the first state to the second state based on the state that is determined at Step S103 and the state data of the storage 9, and stores the determination result in the storage 9.

In a case where the state of the smartphone 1 has not transitioned from a first state to a second state (Step S105, No), there is a low possibility that the smartphone 1 is held over the NFC reader/writer 50 and the like, and thus the controller 10 terminates the procedure illustrated in FIG. 7.

In a case where the state of the smartphone 1 has transitioned from a first state to a second state (Step S105, Yes), the controller 10 proceeds to Step S106. At Step S106, the controller 10 performs a control of allowing the NFC chip 18 to transition from the standby mode to the reader/writer mode. Then, the controller 10 proceeds to Step S107.

In a case where a predetermined time has not passed since the NFC chip 18 was allowed to transition to the reader/writer mode (Step S107, No), the controller 10 repeats the determination processing. In a case where a predetermined time has passed since the NFC chip 18 was allowed to transition to the reader/writer mode (Step S107, Yes), the controller 10 proceeds to Step S108.

At Step S108, the controller 10 determines whether or not a communication has been performed by the NFC chip 18, and stores the determination result in the storage 9. Specifically, the controller 10 determines whether or not the NFC chip 18 has performed a communication based on a communication history and the like after allowing the NFC chip 18 to transition from the standby mode to the reader/writer mode.

In a case where a communication has not been performed by the NFC chip 18 (Step S109, Yes), the controller 10 proceeds to Step S110. At Step S110, the controller 10 performs a control of allowing the NFC chip 18 to transition from the reader/writer mode to the standby mode. Specifically, the controller 10 makes a request for the NFC chip 18 to transition to the standby mode, and updates the mode information of the NFC mode data 9Y to the standby mode. Then, the controller 10 terminates the procedure illustrated in FIG. 7.

In a case where a communication has been performed by the NFC chip 18 (Step S109, No), the controller 10 proceeds to Step S111. At Step S111, the controller 10 keeps the reader/writer mode of the NFC chip 18. That is, the controller 10 terminates the procedure illustrated in FIG. 7 without transitioning the mode of the NFC chip 18.

For example, in a case where the antenna 19 of the NFC chip 18 is disposed to be close to the rear face 1B inside the housing 20, a user performs the hold-over operation in a state in which the smartphone 1 is hold with a hand such that the front face 1A of the touch screen display 2 is covered with the hand. In this regards, description will be given of an example of a control of determining whether or not contact with the touch screen display 2 occurs after the transition from the first state to the second state of the smartphone 1.

In a case where the NFC chip 18 operates in the standby mode, the smartphone 1 can determine a state of the own apparatus based on the detection result of the acceleration sensor 15. In a case where it is determined that a held state in which the own apparatus is held with a hand transitions to a rest state, the smartphone 1 can determine whether or not contact with the touch screen display 2 is detected.

In a case where the contact with the touch screen display 2 is detected, there is a possibility that the hold-over operation by the user may be performed, and thus the smartphone 1 allows the NFC chip 18 to transition from the standby mode to the reader/writer mode. As a result, the NFC chip 18 is in a state in which active transmission is available.

In a case where the contact with the touch screen display 2 is not detected, there is a possibility that the hold-over operation by the user may not be performed, and thus the standby mode of the NFC chip 18 is held. As a result, the NFC chip 18 keeps the state in which active transmission is unavailable.

In this manner, even when it is determined that the state of the smartphone has transitioned to the second state based on the detection result of the acceleration sensor 15, in a case where contact with the touch screen display 2 occurs, the smartphone 1 can allow the NFC chip 18 to transition to the reader/writer mode. As a result, the smartphone 1 can improve detection accuracy of the hold-over operation by the user, and can easily realize power saving.

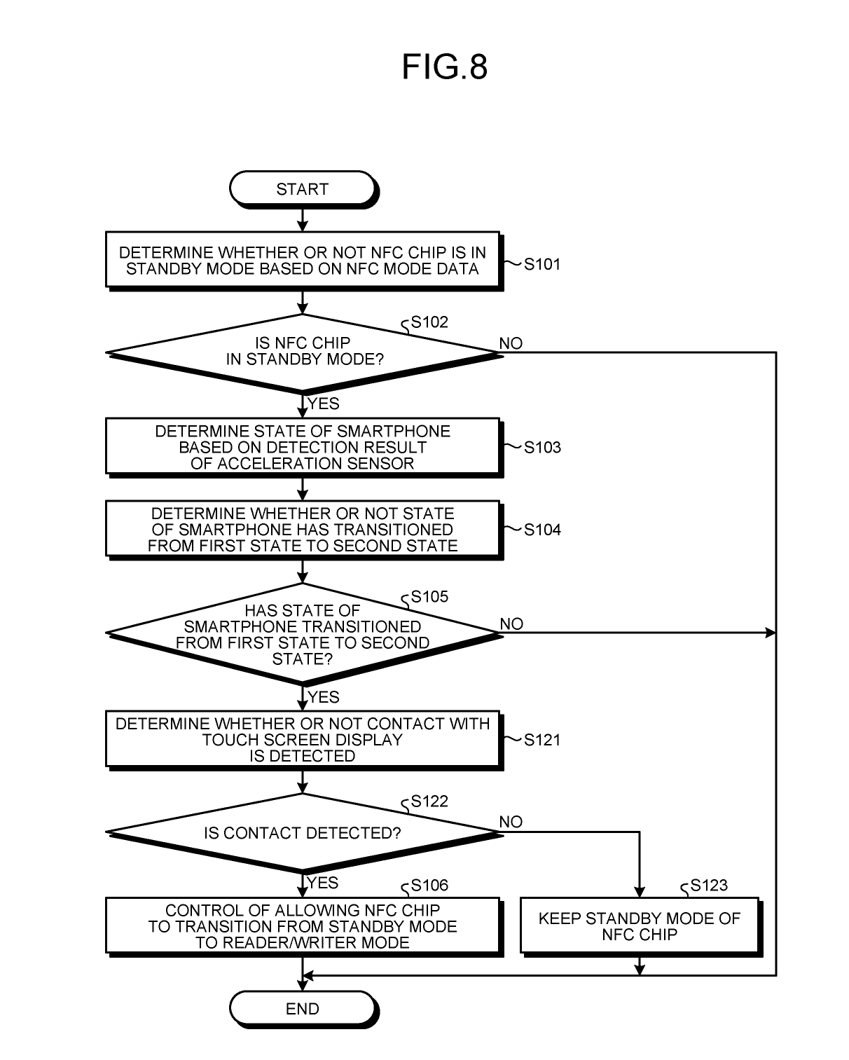

FIG. 8 is a flowchart illustrating a procedure corresponding to another example of a control by the smartphone 1. The procedure illustrated in FIG. 8 is realized when the controller 10 executes the control program 9A. The procedure illustrated in FIG. 8 is repetitively executed in a case where the smartphone 1 performs a control.

As illustrated in FIG. 8, at Step S101, the controller 10 of the smartphone 1 determines whether or not the NFC chip 18 is in the standby mode based on the NFC mode data 9Y of the storage 9. In a case where the NFC chip 18 is not in the standby mode (Step S102, No), the controller 10 terminates the procedure illustrated in FIG. 8.

In a case where the NFC chip 18 is in the standby mode (Step S102, Yes), the controller 10 proceeds to Step S103. At Step S103, the controller 10 determines a state of the smartphone 1 based on a detection result of the acceleration sensor 15, and stores the determination result in the storage 9.

Subsequently, at Step S104, the controller 10 determines whether or not the state of the smartphone 1 has transitioned from the first state to the second state based on the state that is determined at Step S103 and the state data of the storage 9, and stores the determination result in the storage 9.

In a case where the state of the smartphone 1 has not transitioned from a first state to a second state (Step S105, No), the controller 10 terminates the procedure illustrated in FIG. 8.

In a case where the state of the smartphone 1 has transitioned from a first state to a second state (Step S105, Yes), the controller 10 proceeds to Step S121. At Step S121, the controller 10 determines whether or not contact with the touch screen display 2 is detected, and stores the determination result in the storage 9.

In a case where the contact with the touch screen display 2 is detected (Step S122, Yes), the controller 10 proceeds to Step S106. At Step S106, the controller 10 performs a control of allowing the NFC chip 18 to transition from the standby mode to the reader/writer mode. Then, the controller 10 terminates the procedure illustrated in FIG. 8.

In a case where the contact with the touch screen display 2 is not detected (Step S122, No), the controller 10 proceeds to Step S123. At Step S123, the controller 10 keeps the standby mode of the NFC chip 18. That is, the controller 10 terminates the procedure illustrated in FIG. 8 without transitioning the mode of the NFC chip 18.

In the above-described embodiment, description has been given of a case where, when the NFC chip 18 is in the standby mode, if it is determined that the state of the smartphone has transitioned from the held state with a hand to the rest state, the smartphone 1 allows the NFC chip 18 to transition to the reader/writer mode, but there is no limitation thereto. The smartphone 1 may determine whether or not to transition the mode of the NFC chip 18 based on a change of an attitude of the own apparatus until reaching the rest state.

For example, when it is determined that the state of the smartphone has transitioned from the first state to the second state, the controller 10 of the smartphone 1 may allow the NFC chip 18 to be in a state in which active transmission is available based on attitude information of the own apparatus just before the determination as the second state. Examples of the attitude information of the own apparatus include, but are not limited to, information that indicates states of acceleration, an inclination angle, rotation, acceleration of gravity, angular velocity of rotational movement and the like of the own apparatus in time series. For example, in a case where the attitude information of the own apparatus just before the determination as the second state indicates an attitude change corresponding to the hold-over operation of the user, the controller 10 may perform a control of allowing the NFC chip 18 to be in a state in which active transmission is available. For example, in a case where the attitude information of the own apparatus just before the determination as the second state does not indicate the attitude change corresponding to the hold-over operation of the user, the controller 10 may perform a control of keeping the NFC chip 18 in a state in which active transmission is unavailable.

In this manner, when it is determined that the state of the smartphone has transitioned to the second state, the smartphone 1 can set the NFC chip 18 to a state in which active transmission is unavailable based on the attitude information of the own apparatus just before the determination as the second state.

In the above-described embodiment, description has been given of a case where the smartphone 1 is held over the NFC reader/writer 50, but there is no limitation thereto. For example, when being held over a non-contact IC tag that is installed in advertisement or a poster, the smartphone 1 may allow the NFC chip 18 to transition from the standby mode to the reader/writer mode. For example, in a case where it is determined that the attitude of the own apparatus changes to a state of being parallel to the advertisement or the poster and a rest state, the smartphone 1 may allow the NFC chip 18 to transition to the reader/writer mode. Then, the smartphone 1 transmits a carrier wave from the NFC chip 18 to the non-contact IC tag, and displays information of URL, which is acquired from the non-contact IC tag based on the carrier wave, on the touch screen display 2.

In the above-described embodiment, the reader/writer mode of the NFC chip 18 is described as a state in which the active transmission is available, but a P2P mode of the NFC chip may be adopted as a state in which the active transmission is available.

In the above-described embodiment, description has been given of the smartphone as the example of the electronic apparatus, but the electronic apparatus according to the appended claims is not limited to the smartphone. The electronic apparatus according to the appended claims may be an electronic apparatus other than the smartphone. Examples of the electronic apparatus include, but are not limited to, a mobile phone, a tablet, a portable computer, a digital still camera, a media player, an electronic book reader, a navigator, and a game machine.

A specific embodiment has been described so as to completely and clearly disclose a technology according to the appended claims. However, it should be understood that the appended claims are not limited to the above-described embodiment, and are configured to realize the entirety of modification examples and substitutable configurations which can be made by those skilled in the art in a range of basic contents illustrated in this specification.

In this application, description of “when”, “during”, “if”, “in a case”, “upon”, “in response to determining”, “in response to detecting” may be understood as another description depending on circumstances. In this application, description of “when ‘a stated condition or event’ is determined”, “when ‘a stated condition or event’ is detected”, or “upon determining ‘a stated condition or event’”, and description of “in response to determining”, “upon detecting”, or “in response to detecting” may be understood as another description depending on circumstances. In this application, description of “detect” may be understood as meaning of “measure”, “scale”, and “sense” depending on circumstances. In this application, description of “state” may be understood as “situation” depending on circumstances. For example, a moving state may be understood as a moving situation. A state of an electronic apparatus may be understood as a situation of an electronic apparatus.

### REFERENCE SIGNS LIST

1 SMARTPHONE
2 TOUCH SCREEN DISPLAY
2A DISPLAY
2B TOUCH SCREEN
3 BUTTON
4 ILLUMINANCE SENSOR
5 PROXIMITY SENSOR
6 COMMUNICATOR
7 RECEIVER
8 MICROPHONE
9 STORAGE
9A CONTROL PROGRAM
9W ACCELERATION DATA
9X STATE DATA
9Y NFC MODE DATA
9Z SETTING DATA
10 CONTROLLER
11 SPEAKER
12, 13 CAMERA
14 CONNECTOR
15 ACCELERATION SENSOR
16 ORIENTATION SENSOR
17 GYROSCOPE
18 NFC CHIP
19 ANTENNA

1. An electronic apparatus, comprising:
a short range wireless communicator;
a motion sensor; and
at least one controller configured to make active transmission available in the short range wireless communicator when a state of the electronic apparatus is determined to have transitioned from a first state to a second state in a case where the active transmission is unavailable in the short range wireless communicator.

2. The electronic apparatus according to claim 1,
wherein, after having made the active transmission available in the short range wireless communicator, the at least one controller is further configured to make the active transmission unavailable in a case where a communication is not performed by the short range wireless communicator until a predetermined time has passed.

3. The electronic apparatus according to claim 1, further comprising a touch screen display,
wherein the at least one controller is further configured to keep the active transmission unavailable in the short range wireless communicator in a case where a contact with the touch screen display is not detected after the state of the electronic apparatus is determined to have transitioned from the first state to the second state.

4. A control method that is executed by an electronic apparatus including a short range wireless communicator and a motion sensor, the control method comprising:
determining a state of the electronic apparatus based on the motion sensor when the short range wireless communicator is in a state in which active transmission is unavailable; and
making the active transmission available in the short range wireless communicator when the state of the electronic apparatus is determined to have transitioned from the first state to the second state.

5. A non-transitory storage medium that stores a control program allowing an electronic apparatus including a short range wireless communicator and a motion sensor to execute:
determining a state of the electronic apparatus based on the motion sensor when the short range wireless communicator is in a state in which active transmission is unavailable; and
making the active transmission available in the short range wireless communicator when the state of the electronic apparatus is determined to have transitioned from the first state to the second state.
